(19) United States
(12) Patent Application Publication
(10) Pub. No.: US 2007/0075512 A1
(43) Pub. Date: Apr. 5, 2007

(54) Skateboard locking device and method

(76) Inventor: Howard S. Brill, Las Vegas, NV (US)

Correspondence Address: WEISS & MOY PC, 4204 NORTH BROWN AVENUE, SCOTTSDALE, AZ, 85251, US

(21) Appl. No.: 11/242,419

(22) Filed: Oct. 3, 2005

(51) Int. Cl. B62M 1/00

(52) U.S. Cl. 280/87.042

(57) ABSTRACT

A skateboard locking device comprises a plate and an eyelet thereon. The device is interposed between a truck and the underside of a board. A securing means secures between the eyelet and another object, so as to protect against theft of the skateboard.

### FIELD OF THE INVENTION

This invention relates generally to skateboards and, more particular, to a skateboard locking device and method.

### BACKGROUND OF THE INVENTION

Skateboards are popular both for recreational use and for transportation. However, when not in use, consideration must be given to securing the skateboard, so that it will not be vulnerable to theft. Unlike a bicycle, which may be readily locked to a rack or other structure, the typical prior art skateboard may not be readily secured to a fixed object. As a consequence, a user typically has to maintain the skateboard in his or her possession even when not being ridden. This may be inconvenient and, in some instances, not possible.

A need therefore exists for a device and method for locking a skateboard to a fixed object, such as a rack. Such a device and method should, preferably, be capable of integration into more or less any existing skateboard, without requiring alteration of the board or trucks. The device should also, preferably, operate in such manner so as to not interfere with the functionality of the board.

The present invention satisfies these needs and provides other, related, advantages.

### SUMMARY OF THE INVENTION

In accordance with an embodiment of the present invention, a skateboard locking device is disclosed. The device comprises, in combination: a plate adapted to be secured in position between a bottom of a board and a top of a truck; and an eyelet coupled to the plate.

In accordance with another embodiment of the present invention, a skateboard locking device is disclosed. The device comprises, in combination: a skateboard having a board and two trucks coupled to an underside of the board; a plate adapted to be secured in position between the underside of the board and a top of one of the trucks; and an eyelet coupled to the plate.

In accordance with a further embodiment of the present invention, a method for securing a skateboard is disclosed. The method comprises: providing a skateboard comprising a plate adapted to be secured in position between a bottom of a board and a top of a truck; providing an eyelet coupled to the plate; and coupling securing means to each of the eyelet and another object.

### BRIEF DESCRIPTION OF THE DRAWINGS

FIG. 1 is a perspective view of a skateboard having a locking device, consistent with an embodiment of the present invention.

FIG. 2 is a side, partially exploded view of the skateboard and locking device of FIG. 1.

FIG. 3 is perspective view of a locking device consistent with an embodiment of the present invention.

FIG. 4 is a side view illustrating securing of the locking device of FIG. 3 with a securing means.

### DETAILED DESCRIPTION OF THE PREFERRED EMBODIMENTS

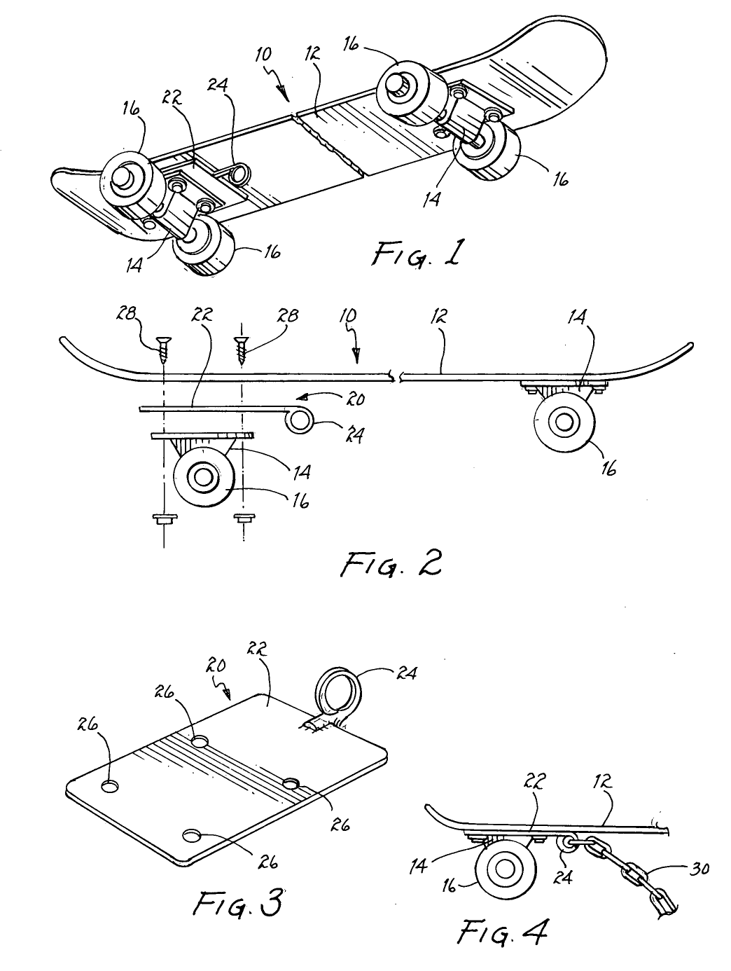

Referring first to FIG. 1-2, the main components of a skateboard 10 are shown. These include a board 12, two trucks 14 secured to an underside of the board 12, and two wheels 16 mounted to each of the two trucks 14.

Referring now to FIGS. 2-3, a locking device (“device”) 20 consistent with an embodiment of the present invention is shown and described. In this embodiment, the device 20 comprises a plate 22 and an eyelet 24 secured thereto. The plate 22 and eyelet 24 should preferably be formed from a relatively strong material, such as metal, so as to be relatively resistant to breaking or cutting by a person seeking to steal the skateboard 10 to which the device 20 is secured. It may be desired to form the eyelet 24 separately from the plate 22, and to weld or otherwise attach the eyelet 24 to the plate 22 for use.

As best seen in FIGS. 1-2 and 4, preferably the eyelet 24 is attached to the plate 22 in a manner so as to be flush with the plate 22 along one edge of the eyelet 24. In this manner, when the device 20 is secured in position, as hereinafter described, both the plate 22 and an edge of the eyelet 24 may abut an underside of the board 12, with the remaining portion of the eyelet 24 projecting downward.

With respect to attachment of the device 20, as best seen in FIGS. 2-3, it is preferred to provide on the plate 22 a plurality of openings 26, corresponding to openings in the board 12 and trucks 14, through which securing bolts 28 are typically inserted so as to secure the trucks 14 to the board 12. This permits interpositioning of the device 20 between the trucks 14 and the underside of the board 12, and the securing of the device 20 in position by insertion of the bolts 28 through each of the board 12, openings 26, and trucks 14. As noted above, the device 20 should be secured in an orientation so that the eyelet 24 projects downward.

As also seen in FIGS. 1-2 and 4, it is preferred to couple the device 20 so that the eyelet 24 is located between the trucks 14. In this manner, the eyelet 24 should not unduly interfere with operation of the skateboard 10, including for example railstands (where a side of the board is positioned against the ground) or maneuvers whereby a rider may wish to lift one end of the board 12, causing the other end to draw nearer to the ground, such as an Ollie or a Manual (wheelie). If the eyelet 24 extended behind or forward one of the trucks 14, rather than being interposed between them, or to the side of the trucks 14, the eyelet 24 could interfere with such maneuvers.

However, certain users may desire to position the eyelet 24 so as to extend behind or forward one of the trucks 14, rather than between them, where the user wishes to perform maneuvers in which an eyelet 24 positioned as shown in FIGS. 1-2 could cause interference. For some uses, it may be desired to provide a device 20 in which the eyelet 24 extends to the side of a truck 14 (i.e., 90 degrees from the direction shown in FIGS. 1-2).

It should be noted that while the device 20 is shown as being interposed directly between the board 12 and trucks 14, a user may wish to also interpose shock absorbing material (not shown) between the board 12 and trucks 14. In such instance, the device 20 could also be secured in the space between the board 12 and trucks 14, together with such material.

Referring now to FIG. 4, once in position, the device 20 may be secured by inserting a securing means 30 therethrough. The securing means 30 may be a cable, chain, rigid lock, or other device suitable for use in securing an object against theft. The securing means should also be secured to another object, such as a rack, so as to provide theft protection.

While the invention has been particularly shown and described with reference to preferred embodiments thereof, it will be understood by those skilled in the art that the foregoing and other changes in form and details may be made therein without departing from the spirit and scope of the invention.

I claim:

1. A skateboard locking device comprising, in combination:
a plate adapted to be secured in position between a bottom of a board and a top of a truck; and
an eyelet coupled to the plate.

2. The device of claim 1 wherein the plate has a plurality of openings therethrough, configured so as to permit the passage therethrough of bolts coupling the truck to the board.

3. The device of claim 1 wherein, when the plate is in position between the bottom of the board and the top of the truck, the eyelet is interposed between the truck and a second truck.

4. The device of claim 1 further comprising a securing means adapted to be coupled to each of the eyelet and another object.

5. A skateboard locking device comprising, in combination:
a skateboard having a board and two trucks coupled to an underside of the board;
a plate adapted to be secured in position between the underside of the board and a top of one of the trucks; and
an eyelet coupled to the plate.

6. The device of claim 5 wherein the plate has a plurality of openings therethrough, configured so as to permit the passage therethrough of bolts coupling the one of the trucks to the board.

7. The device of claim 5 wherein, when the plate is in position between the bottom of the board and the top of the truck, the eyelet is interposed between the two trucks.

8. The device of claim 5 further comprising a securing means adapted to be coupled to each of the eyelet and another object.

9. A method for securing a skateboard comprising:
providing a skateboard comprising a plate adapted to be secured in position between a bottom of a board and a top of a truck;
providing an eyelet coupled to the plate; and
coupling securing means to each of the eyelet and another object.

10. The method of claim 9 wherein the plate has a plurality of openings therethrough, configured so as to permit the passage therethrough of bolts coupling the truck to the board.

11. The method of claim 9 wherein, when the plate is in position between the bottom of the board and the top of the truck, the eyelet is interposed between the truck and a second truck.

12. The method of claim 9 further comprising a securing means adapted to be coupled to each of the eyelet and another object.
